(19) United States
(12) Patent Application Publication
(10) Pub. No.: US 2007/0064749 A1
(43) Pub. Date: Mar. 22, 2007

(54) Deep ultraviolet laser apparatus

(75) Inventors: Yushi Kaneda, Wako-shi (JP); Yoshiharu Urata, Wako-shi (JP); Satoshi Wada, Wako-shi (JP); Shinichi Imai, Kawasaki-shi (JP)

Correspondence Address: BIRCH STEWART KOLASCH & BIRCH, PO BOX 747, FALLS CHURCH, VA, 22040-0747, US

(73) Assignees: Megaopto Co., Ltd.; Advanced Mask Inspection Technology Inc.

(21) Appl. No.: 11/523,027

(22) Filed: Sep. 19, 2006

(30) Foreign Application Priority Data
Sep. 20, 2005 (JP) 2005-271310

(51) Int. Cl. H01S 3/10

(52) U.S. Cl. 372/21

(57) ABSTRACT

In order to generate efficiently a deep ultraviolet laser beam having a wavelength in a deep ultraviolet region and to make the generated laser beam to be high output, it is arranged in such that a laser beam having about 227 nm wavelength is generated by sum-frequency mixing of fourth harmonic of the laser beams obtained by amplifying semiconductor laser beams having 1064.0 to 1065.0 nm wavelengths by means of an optical fiber amplifier, and the laser beams obtained by amplifying semiconductor laser beams having 1557.0 to 1571.0 nm wavelengths by means of another optical fiber amplifier; and further laser beams having 198.4 to 198.7 nm wavelengths are generated by sum-frequency mixing of the above sum-frequency mixed laser beam and the above-described semiconductor laser beams having 1557.0 to 1571.0 nm wavelengths.

### BACKGROUND OF THE INVENTION

1. Field of the Invention

The present invention relates to a deep ultraviolet laser apparatus, and more particularly to a deep ultraviolet laser apparatus for generating deep ultraviolet laser beam having wavelengths (ranging from 190 to 270 nm wavelengths) in deep ultraviolet region by utilizing a wavelength conversion technology to which nonlinear optical effects are applied.

2. Description of the Related Art

In recent years, a variety of deep ultraviolet laser apparatuses for generating deep ultraviolet laser beam are proposed with aiming to apply to a fine processing technology in, for example, electronics industrial fields such as manufacturing processes of semiconductors and the like.

Such conventional deep ultraviolet laser apparatus has been constituted so as to generate a deep ultraviolet laser beam having a target wavelength by the application of the wavelength conversion technology using nonlinear optical effects.

More specifically, in the conventional deep ultraviolet laser apparatus, it is adapted to obtain the laser beam having a target wavelength by multiplying a frequency of laser beam due to harmonic generation, or by means of sum-frequency generation wherein existing lasers are combined to generate a laser beam having a sum of the frequencies of laser beams derived from two input lasers.

However, there is such problem that it is difficult to generate a laser beam of 190 to 200 nm wavelength region in simple second harmonic generation (to obtain a twofold frequency, i.e. a half wavelength), or the repetition harmonic generation.

It is also difficult likewise to generate a laser beam in 190 to 200 nm wavelength region in sum-frequency generation by the combination of the wavelengths of a solid laser used commonly.

On one hand, a material having sufficient transparency in the 190 to 200 nm wavelength region is restricted among those having optical nonlinearity; and further there are little crystals satisfying phase matching conditions required for effective wavelength conversion. In these circumstances, there is also a difficult problem to generate a laser beam in the 190 to 200 nm wavelength region.

In the meantime, it is known that nonlinearity of a nonlinear optical medium in which laser wavelength conversion is effected is in an order of pm/V so that efficient wavelength conversion cannot be made by passing simply a laser beam through the medium. For this reason, such a manner that an outside resonator is used, and a nonlinear medium is disposed in a laser beam confined within the outside resonator, whereby wavelength conversion efficiency is improved has been heretofore used.

In the manner as described, however, it is required to synchronize a resonator length of the outside resonator with a value corresponding to an integral multiplication of the wavelength of the laser beam. Accordingly, there is such a problem that a complicated servo system for eliminating the above-described requirement becomes necessary, resulting in a complicated constitution therefor. Moreover, it has been also pointed out that an optical loss of the outside resonator must be kept to be a small amount.

In addition, a technology in which 198.5 nm laser beam is intended to generate by means of sum-frequency generation of the second harmonic of argon laser and an Nd:YAG laser is known as an application of the above-described manner of using the outside resonator. However, since the manner of using the outside resonator involves the above-described problem, it is difficult to use widely in industrial use application.

On the other hand, such a manner that a peak-to-peak value of power is increased to increase nonlinear wavelength conversion efficiency is proposed as an application of pulse laser. In this respect, a light source generating a laser beam of 193.4 nm wavelength by means of eighth harmonic derived from a laser light source of 1.547 μm wavelength is realized as an application of an optical communication device. The 193.4 nm wavelength derived from such light source as described above is common to that of a laser beam obtained by argon fluoride laser; and such wavelength is watched very interestingly in a field of semiconductor manufacture.

In view of a variety of the backgrounds as described above, it is strongly desired at present to propose an ultraviolet laser apparatus which can generate efficiently a deep ultraviolet laser beam having a wavelength in the deep ultraviolet region, and further the deep ultraviolet laser beam can be intensified thereby.

### OBJECT AND SUMMARY OF THE INVENTION

The present invention has been made in view of the above-described needs involved in the prior art, and an object of the invention is to provide an ultraviolet laser apparatus which can generate efficiently a deep ultraviolet laser beam having a wavelength of about 199 nm.

A further object of the present invention is to provide an ultraviolet laser apparatus which can generate a deep ultraviolet laser beam having a wave length of about 199 nm in high output.

A still further object of the present invention is to provide an ultraviolet laser apparatus which can generate a deep ultraviolet laser beam having a wave length of about 199 nm while intending to achieve a low cost.

An yet further object of the present invention is to provide an ultraviolet laser apparatus which can generate a deep ultraviolet laser beam having a wave length of about 199 nm while improving remarkably its reliability.

In order to achieve the above-described objects, the deep ultraviolet laser apparatus according to the present invention is adapted to generate a laser beam having about 227 nm wavelength by sum-frequency mixing of fourth harmonic of the laser beams obtained by amplifying semiconductor laser beams having 1064.0 to 1065.0 nm wavelengths by means of an optical fiber amplifier, and the laser beams obtained by amplifying semiconductor laser beams having 1557.0 to 1571.0 nm wavelengths by means of another optical fiber amplifier; and further to generate laser beams having 198.4 to 198.7 nm wavelengths by sum-frequency mixing of the above sum-frequency mixed laser beam and the above-described semiconductor laser beams having 1557.0 to 1571.0 nm wavelengths.

Namely, the present invention may be a deep ultraviolet laser apparatus including a first semiconductor laser for outputting a laser beam having a wavelength of from 1064.0 to 1065.0 nm; a second semiconductor laser for outputting a laser beam having a wavelength of from 1557.0 to 1571.0 nm; a pulse current source for applying a pulsed current for driving the first semiconductor laser and the second semiconductor laser; a first optical fiber amplifier for amplifying the laser beam having a wavelength of from 1064.0 to 1065.0 nm output from the first semiconductor laser; a second optical fiber amplifier for amplifying the laser beam having a wavelength of from 1557.0 to 1571.0 nm output from the second semiconductor laser; a first nonlinear optical crystal for inputting the laser beams having wavelengths of from 1064.0 to 1065.0 nm output from the first optical fiber amplifier to output the second harmonic of a laser beams having 1064.0 to 1065.0 nm wavelengths due to second harmonic generation; a second nonlinear optical crystal for inputting the second harmonic output from the first nonlinear optical crystal to output fourth harmonic of laser beams having wavelengths of from 1064.0 to 1065.0 nm due to second harmonic generation; a third nonlinear optical crystal for inputting the fourth harmonic output from the second nonlinear optical crystal and the laser beams having wavelengths of from 1557.0 to 1571.0 nm output from the second optical fiber amplifier to output the laser beams wavelength-converted by means of sum-frequency generation; and a fourth nonlinear optical crystal for inputting the wavelength-converted laser beams output from the third nonlinear optical crystal and the laser beams having wavelengths of from 1557.0 to 1571.0 nm transmitting the third nonlinear optical crystal, the laser beams being not converted after the sum-frequency generation process derived from the third nonlinear optical crystal, to output laser beams having wavelengths of from 198.4 to 198.7 nm by means of wavelength conversion due to the sum-frequency generation.

The deep ultraviolet laser apparatus according to the present invention may further include a first condenser lens disposed on the end portion of the output side of the first optical fiber amplifier and for condensing the laser beams having wavelengths of from 1064.0 to 1065.0 nm output from the first optical fiber amplifier to input the condensed laser beams to the first nonlinear optical crystal; and a second condenser lens disposed on the end portion of the output side of the second optical fiber amplifier and for condensing the laser beams having wavelengths of from 1557.0 to 1571.0 nm output from the second optical fiber amplifier to input the condensed laser beams to the third nonlinear optical crystal.

Furthermore, in the deep ultraviolet laser apparatus according to the present invention, the first optical fiber amplifier and the second optical fiber amplifier may be rare-earth doped optical fiber amplifiers.

Moreover, in the deep ultraviolet laser apparatus according to the present invention, the first optical fiber amplifier may be an ytterbium-doped fiber amplifier; and the second optical fiber amplifier may be an erbium-doped optical fiber amplifier.

Still further, in the deep ultraviolet laser apparatus according to the present invention, the first nonlinear optical crystal may be a LBO crystal, a PPLN crystal, or a PPLT crystal; the second nonlinear optical crystal may be a BBO crystal, or a CLBO crystal; the third nonlinear optical crystal may be a BBO crystal, a LBO crystal, or a CLBO crystal; and the fourth nonlinear optical crystal may be a BBO crystal, or a CLBO crystal.

Yet further, in the deep ultraviolet laser apparatus according to the present invention, the first semiconductor laser may be driven in synchronous with the second semiconductor laser by means of current modulation derived from the pulse current source.

According to the above-described invention, such an excellent advantageous effect of generating efficiently a deep ultraviolet laser beam having about 199 nm wavelength can be achieved.

Moreover, according to the present invention, such an excellent advantageous effect of generating a deep ultraviolet laser beam having about 199 nm wavelength in high output can be achieved.

Furthermore, according to the present invention, such an excellent advantageous effect of generating a deep ultraviolet laser beam having about 199 nm wavelength can be achieved while intending to keep low costs.

Still further, according to the present invention, such an excellent advantageous effect of generating a deep ultraviolet laser beam having about 199 nm wavelength can be achieved while improving remarkably its reliability.

The deep ultraviolet apparatus according to the present invention as mentioned above may be applied to microfabrication or inspection and the like of microstructure in electronics industrial fields.

### BRIEF DESCRIPTION OF THE DRAWING

The present invention will become more fully understood from the detailed description given hereinbelow and the accompanying drawing which is given by way of illustration only, and thus is not limitative of the present invention, and wherein:

FIG. 1 is a conceptual constitutional explanatory diagram showing an example of a manner of practice of the present invention.

### DETAILED DESCRIPTION OF THE PREFERRED EMBODIMENTS

In the following, an example of a manner of practice of the deep ultraviolet laser apparatus according to the present invention will be described in detail by referring to the accompanying drawing.

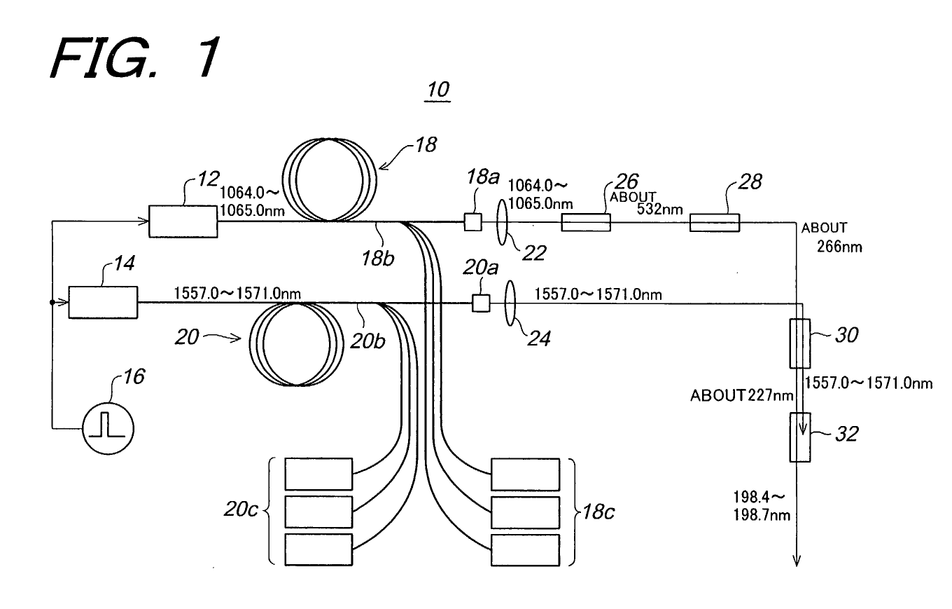

FIG. 1 is a conceptual constitutional explanatory diagram showing a deep ultraviolet laser apparatus 10 according to an example of a manner of practice of the present invention.

The deep ultraviolet laser apparatus 10 is composed of a first semiconductor laser 12 for outputting laser beams having 1064.0 to 1065.0 nm wavelengths, a second semiconductor laser 14 for outputting laser beams having 1557.0 to 1571.0 nm wavelengths, a pulse current source 16 for applying a pulsed current for driving the first semiconductor laser 12 and the second semiconductor laser 14, a first optical fiber amplifier 18 for amplifying the laser beam having a wavelength of from 1064.0 to 1065.0 nm output from the first semiconductor laser 12, a second optical fiber amplifier 20 for amplifying the laser beams having 1557.0 to 1571.0 nm wavelengths output from the second semiconductor laser 14, a first condenser lens 22 for condensing the laser beams having 1064.0 to 1065.0 nm wavelengths output from the end portion 18, a on the output side of the first optical fiber amplifier 18a second condenser lens 24 for condensing the laser beams having 1557.0 to 1571.0 nm wavelengths output from the end portion 20a on the output side of the second optical fiber amplifier 20, a first nonlinear optical crystal 26 for inputting the laser beams having 1064.0 to 1065.0 nm wavelengths output from the first condenser lens 22 to output a laser beam having about 532 nm wavelength as second harmonic due to second harmonic generation, a second nonlinear optical crystal 28 for inputting the laser beam having about 532 nm wavelength output from the first nonlinear optical crystal 26 to output a laser beam having about 266 nm wavelength as fourth harmonic of laser beams having 1064.0 to 1065.0 nm wavelengths due to second harmonic generation, a third nonlinear optical crystal 30 for inputting the laser beam having about 266 nm wavelength output from the second nonlinear optical crystal 28 and the laser beams having 1557.0 to 1571.0 nm wavelengths output from the second condenser lens 24 to output a laser beam having about 227 nm wavelength by means of wavelength conversion due to sum-frequency generation, and a fourth nonlinear optical crystal 32 for inputting a laser beam having about 227 nm wavelength output from the third nonlinear optical crystal 30 and the laser beams having 1557.0 to 1571.0 nm wavelengths transmitting the third nonlinear optical crystal 30 so that they are not contributed to sum-frequency generation derived from the third nonlinear optical crystal 30 to output laser beams having 198.4 to 198.7 nm wavelengths by means of wavelength conversion due to sum-frequency generation.

In order to simplify the explanation and make understanding of the present invention easy, although the description and illustration are omitted as to an optical system such as an all-reflective mirror for making the light path of a laser beam variable, such light path of laser beam may make to be variable as a matter of course. In the manner of practice shown in FIG. 1, for example, when the laser beam having about 266 nm wavelength output from the second linear optical crystal 28 and the laser beams having 1557.0 to 1571.0 nm wavelengths output from the second condenser lens 24 are input to the third nonlinear optical crystal 30, the light paths of the respective laser beams are bent as illustrated in FIG. 1 by means of an all-reflective mirror (not shown) to be input.

The first semiconductor laser 12 may be composed of, for example, InGaAs-base semiconductor lasers, while the second semiconductor laser 14 maybe composed of, for example, a DFB laser (the DFB laser means a semiconductor laser wherein a diffraction grating is formed inside a laser chip, and only the light having a specified wavelength is allowed to reflect to confine the light into the active region, whereby a laser beam is oscillated).

The first optical fiber amplifier 18, the input side end of which is connected to the output end of the first semiconductor laser 12, is composed of an optical fiber 18b the output side end 18a of which is disposed adjacent to the first condenser lens 22, and a group of pump lasers 18c for inputting excitation light to the optical fiber 18b.

On one hand, second optical fiber amplifier 20, the input side end of which is connected to the output end of the second semiconductor laser 14, is composed of an optical fiber 20b the output side end 20a of which is disposed adjacent to the second condenser lens 24, and a group of pump lasers 20c for inputting excitation light to the optical fiber 20b.

In the first optical fiber amplifier 18 and the second optical fiber amplifier 20, intensities of the laser beams output from the optical fibers 18b and 20b are decided in response to output intensities of the excitation lights input to the optical fibers 18b and 20b. For this reason, each of the groups of pump lasers 18c and 20c is composed of three excitation lasers, respectively, for the purpose of increasing the output intensity of the excitation lights.

The above-described first optical fiber amplifier 18 and the second optical fiber amplifier 20 may be composed of, for example, a rare-earth doped optical fiber amplifier. More specifically, the first optical fiber amplifier 18 maybe composed of, for example, an ytterbium-doped fiber amplifier (YDFA), while the second optical fiber amplifier 20 may be composed of, for example, an erbium-doped optical fiber amplifier (EDFA).

Furthermore, the first nonlinear optical crystal 26 may be composed of, for example, LBO crystal, PPLN crystal or PPLT crystal; the second nonlinear optical crystal 28 may be composed of, for example, BBO crystal, or CLBO crystal; the third nonlinear optical crystal 30 may be composed of, for example, BBO crystal, LBO crystal, or CLBO crystal; and the fourth nonlinear optical crystal 32 may be composed of, for example, BBO crystal, or CLBO crystal.

In the above-described constitution, although operations of the above-described deep ultraviolet laser apparatus 10 are described, nonlinear optical effects such as second harmonic generation for generating the laser beams wavelength-converted by inputting a laser beam having a certain wavelength to a nonlinear optical crystal, and sum-frequency generation for generating laser beams wavelength-converted by inputting two types of laser beams having frequencies different from one another have been well-known, the detailed description thereof is omitted.

First, when a pulsed current is applied to the first semiconductor laser 12 and the second semiconductor laser 14 from the pulse current source 16 to drive the first semiconductor laser 12 in synchronous with the second semiconductor laser 14 by means of current modulation, laser beams having 1064.0 to 1065.0 nm wavelengths are output from the first semiconductor laser 12 in synchronous with the laser beams having 1557.0 to 1571.0 nm wavelengths output from the second semiconductor laser 14, respectively.

Now, the laser beams having 1064.0 to 1065.0 nm wavelengths are input to the first optical fiber amplifier 18, and they are amplified during transit of the first optical fiber amplifier 18 to output the laser beams having 1064.0 to 1065.0 nm wavelengths from the output side end 18a at high output.

Then, the laser beams having 1064.0 to 1065.0 nm wavelengths output from the output side end 18a are input to the first nonlinear optical crystal 26, whereby the laser beams having 1064.0 to 1065.0 nm wavelengths input to the first nonlinear optical crystal 26 are wavelength-converted to the laser beam having about 532 nm wavelength being second harmonic due to second harmonic generation which is the nonlinear optical effect of the first nonlinear optical crystal 26, and as a result, the laser beam having about 532 nm wavelength is output from the first nonlinear optical crystal 26.

Next, the laser beam having about 532 nm wavelength output from the first nonlinear optical crystal 26 is input to the second nonlinear optical crystal 28, the laser beam having about 532 nm wavelength input to the second nonlinear optical crystal 28 is wavelength-converted to the laser beam having about 266 nm wavelength which corresponds to fourth harmonic having 1064.0 to 1065.0 nm wavelengths due to second harmonic generation being the nonlinear optical effect of the second nonlinear optical crystal 28, whereby the laser beam having about 266 nm wavelength is output from the second nonlinear optical crystal 28.

On one hand, the laser beams having 1557.0 to 1571.0 nm wavelengths output from the second semiconductor laser 14 are input to the second optical fiber amplifier 20, and they are amplified during transit of the second optical fiber amplifier 20 to output the laser beams having 1557.0 to 1571.0 nm wavelengths are output from the output side end 20a at high output.

Then, the laser beam having about 266 nm wavelength output from the second nonlinear optical crystal 28 is input to the third nonlinear optical crystal 30 in synchronous with the laser beams having 1557.0 to 1571.0 nm wavelengths output from the output side end 20a. In the third nonlinear optical crystal 30, the input laser beam having about 266 nm wavelength and laser beams having 1557.0 to 1571.0 nm wavelengths are wavelength-converted to the laser beam having about 227 nm wavelength due to sum-frequency generation being the nonlinear optical effect, and thus, it is output.

Furthermore, the laser beam having about 227 nm wavelength output from the third nonlinear optical crystal 30 is input to the fourth nonlinear optical crystal 32, and the transmitted laser beams having 1557.0 to 1571.0 nm wavelengths which are not contributed to wavelength conversion due to the sum-frequency generation in the third nonlinear optical crystal 30 are similarly input to the fourth nonlinear optical crystal 32.

In the fourth nonlinear optical crystal 32, the input laser beam having about 277 nm wavelength and laser beams having 1557.0 to 1571.0 nm wavelengths are wavelength-converted to the laser beam having 198.4 to 198.7 nm wavelengths due to the sum-frequency generation being the nonlinear optical effect, and thus, it is output.

Hence, according to the deep ultraviolet apparatus 10, pulsed currents are applied to the first semiconductor laser 12 and the second semiconductor laser 14 from the pulse current source 16, whereby the first semiconductor laser 12 and the second semiconductor laser 14 are driven by means of current modulation. Accordingly, it is very easy to control an input timing of laser beams in the case where sum-frequency generation is made in the third nonlinear optical crystal 30 and the fourth nonlinear optical crystal 32, so that it becomes possible to improve generation efficiency of the sum-frequency generation, and consequently, the laser beams having 198.4 to 198.7 nm wavelengths can be efficiently generated.

According to the deep ultraviolet laser apparatus 10, the laser beam output from the first semiconductor laser 12 and the laser beam output from the second semiconductor laser 14 are wavelength-converted after the former laser beam having been amplified by the first optical fiber amplifier 18 and the latter laser beam having been amplified by the second optical fiber amplifier 20, and thus, the laser beams having 198.4 to 198.7 nm wavelengths can be generated at high output.

Furthermore, the deep ultraviolet laser apparatus 10 may be constituted by using semiconductor lasers, optical fiber amplifiers, or nonlinear optical crystals which have been commonly utilized heretofore, and hence, the laser beams having 198.4 to 198.7 nm wavelengths can be generated while intending to keep a low cost.

Moreover, the deep ultraviolet laser apparatus 10 may be constituted by using semiconductor lasers, optical fiber amplifiers, or nonlinear optical crystals which have exhibited stable performance heretofore, and as a result, the laser beams having 198.4 to 198.7 nm wavelengths can be generated while improving remarkably its reliability.

Besides, according to the deep ultraviolet laser apparatus 10, repetition frequencies of the first semiconductor laser 12 and the second semiconductor laser 14 are controlled by current modulation, and accordingly, it becomes possible to generate a high repetition frequency wherein the repetition frequency is 1 MHz or more.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2005-271310 filed on Sep. 20, 2005 including specification, claims, drawing and summary are incorporated herein by reference in its entirety.

What is claimed is:

1. The deep ultraviolet laser apparatus, comprising:
a first semiconductor laser for outputting a laser beam having a wavelength of from 1064.0 to 1065.0 nm;
a second semiconductor laser for outputting a laser beam having a wavelength of from 1557.0 to 1571.0 nm;
a pulse current source for applying a pulsed current for driving the first semiconductor laser and the second semiconductor laser;
a first optical fiber amplifier for amplifying the laser beam having a wavelength of from 1064.0 to 1065.0 nm output from the first semiconductor laser;
a second optical fiber amplifier for amplifying the laser beam having a wavelength of from 1557.0 to 1571.0 nm output from the second semiconductor laser;
a first nonlinear optical crystal for inputting the laser beams having wavelengths of from 1064.0 to 1065.0 nm output from the first optical fiber amplifier to output the second harmonic of a laser beams having 1064.0 to 1065.0 nm wavelengths due to second harmonic generation;
a second nonlinear optical crystal for inputting the second harmonic output from the first nonlinear optical crystal to output fourth harmonic of laser beams having wavelengths of from 1064.0 to 1065.0 nm due to second harmonic generation;
a third nonlinear optical crystal for inputting the fourth harmonic output from the second nonlinear optical crystal and the laser beams having wavelengths of from 1557.0 to 1571.0 nm output from the second optical fiber amplifier to output the laser beams wavelength-converted by means of sum-frequency generation; and
a fourth nonlinear optical crystal for inputting the wavelength-converted laser beams output from the third nonlinear optical crystal and the laser beams having wavelengths of from 1557.0 to 1571.0 nm transmitting the third nonlinear optical crystal, the laser beams being not converted after the sum-frequency generation process derived from the third nonlinear optical crystal, to output laser beams having wavelengths of from 198.4 to 198.7 nm by means of wavelength conversion due to the sum-frequency generation.

2. The deep ultraviolet laser apparatus as claimed in claim 1, comprising further:
a first condenser lens disposed on the end portion of the output side of the first optical fiber amplifier and for condensing the laser beams having wavelengths of from 1064.0 to 1065.0 nm output from the first optical fiber amplifier to input the condensed laser beams to the first nonlinear optical crystal; and
a second condenser lens disposed on the end portion of the output side of the second optical fiber amplifier and for condensing the laser beams having wavelengths of from 1557.0 to 1571.0 nm output from the second optical fiber amplifier to input the condensed laser beams to the third nonlinear optical crystal.

3. The deep ultraviolet laser apparatus as claimed in any one of claims 1 and 2, wherein:
the first optical fiber amplifier and the second optical fiber amplifier are rare-earth doped optical fiber amplifiers.

4. The deep ultraviolet laser apparatus as claimed in claim 3, wherein:
the first optical fiber amplifier is an ytterbium-doped fiber amplifier; and
the second optical fiber amplifier is an erbium-doped optical fiber amplifier.

5. The deep ultraviolet laser apparatus as claimed in any one of claims 1 and 2, wherein:
the first nonlinear optical crystal is a LBO crystal, a PPLN crystal, or a PPLT crystal;
the second nonlinear optical crystal is a BBO crystal, or a CLBO crystal;
the third nonlinear optical crystal is a BBO crystal, a LBO crystal, or a CLBO crystal; and
the fourth nonlinear optical crystal is a BBO crystal, or a CLBO crystal.

6. The deep ultraviolet laser apparatus as claimed in claim 3, wherein:
the first nonlinear optical crystal is a LBO crystal, a PPLN crystal, or a PPLT crystal;
the second nonlinear optical crystal is a BBO crystal, or a CLBO crystal;
the third nonlinear optical crystal is a BBO crystal, a LBO crystal, or a CLBO crystal; and
the fourth nonlinear optical crystal is a BBO crystal, or a CLBO crystal.

7. The deep ultraviolet laser apparatus as claimed in claim 4, wherein:
the first nonlinear optical crystal is a LBO crystal, a PPLN crystal, or a PPLT crystal;
the second nonlinear optical crystal is a BBO crystal, or a CLBO crystal;
the third nonlinear optical crystal is a BBO crystal, a LBO crystal, or a CLBO crystal; and
the fourth nonlinear optical crystal is a BBO crystal, or a CLBO crystal.

8. The deep ultraviolet laser apparatus as claimed in any one of claims 1 and 2, wherein:
the first semiconductor laser is driven in synchronous with the second semiconductor laser by means of current modulation derived from the pulse current source.

9. The deep ultraviolet laser apparatus as claimed in claim 3, wherein:
the first semiconductor laser is driven in synchronous with the second semiconductor laser by means of current modulation derived from the pulse current source.

10. The deep ultraviolet laser apparatus as claimed in claim 4, wherein:
the first semiconductor laser is driven in synchronous with the second semiconductor laser by means of current modulation derived from the pulse current source.

11. The deep ultraviolet laser apparatus as claimed in claim 5, wherein:
the first semiconductor laser is driven in synchronous with the second semiconductor laser by means of current modulation derived from the pulse current source.

12. The deep ultraviolet laser apparatus as claimed in claim 6, wherein:
the first semiconductor laser is driven in synchronous with the second semiconductor laser by means of current modulation derived from the pulse current source.

13. The deep ultraviolet laser apparatus as claimed in claim 7, wherein:
the first semiconductor laser is driven in synchronous with the second semiconductor laser by means of current modulation derived from the pulse current source.
